(19) United States
(12) Patent Application Publication
(10) Pub. No.: US 2014/0042847 A1
(43) Pub. Date: Feb. 13, 2014

(54) SPINDLE MOTOR

(71) Applicant: SAMSUNG ELECTRO-MECHANICS CO., LTD., Suwon (KR)

(72) Inventors: Hyun Gi YANG, Suwon (KR); Sung Hoon Kim, Suwon (KR)

(73) Assignee: SAMSUNG ELECTRO-MECHANICS CO., LTD., Suwon (KR)

(21) Appl. No.: 13/772,614

(22) Filed: Feb. 21, 2013

(30) Foreign Application Priority Data
Aug. 10, 2012 (KR) 10-2012-0087549

(51) Int. Cl. H02K 7/08

(52) U.S. Cl. CPC H02K 7/08
USPC 310/90

(57) ABSTRACT

A spindle motor includes a sleeve fixed to a base member, a shaft rotatably inserted into a shaft hole of the sleeve, and a rotor hub fixed to an upper end of the shaft. A protrusion having a corresponding inclined surface that defines a bearing clearance together with an outer circumferential surface of the sleeve is disposed on an inner diameter part of the rotor hub.

### CROSS-REFERENCE TO RELATED APPLICATIONS

This application claims the priority of Korean Patent Application No. 10-2012-0087549 filed on Aug. 10, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

In general, a small spindle motor used in a hard disk drive (HDD) rotates a disk so that a magnetic head is able to record data on the disk or read data from the disk.

Also, the spindle motor includes a hydrodynamic bearing assembly. Here, a lubricating fluid is filled in a bearing clearance formed in the hydrodynamic bearing assembly.

When a shaft rotates, the lubricating fluid filled into the bearing clearance is pumped to generate a hydrodynamic pressure, thereby rotatably supporting the shaft.

However, when the shaft rotates, an area of pressure lower than atmospheric pressure, i.e., negative pressure, may be generated in the fluid by the pumping thereof.

In this case, air components contained within the lubricating fluid may expand to generate bubbles. Then, when the bubbles are introduced into a groove for pumping the lubricating fluid, hydrodynamic pressure may not be sufficiently generated, and also, vibrations may occur to reduce rotation characteristics.

As a result, a circulation hole for reducing the occurrence of negative pressure is formed in a sleeve. Thus, the occurrence of the negative pressure may be restrained by the circulation hole.

Among the following prior-art documents, US Publication Application No. 2008-283120 discloses a structure in which a circulation hole for reducing an occurrence of negative pressure is slopingly formed, and the circulation hole connects a bearing clearance formed by a sleeve and cover member to a bearing clearance in which a gas-liquid interface is formed.

However, it may be difficult to form the circulation hole. In addition, when the circulation hole is formed, a faulty sleeve may occur.

Recently, with the trend for compact recording disk driving devices, there is a growing trend toward miniaturized and compact spindle motors. Thus, a rotor hub coupled to a shaft may be decreased in thickness, allowing for a compact spindle motor.

However, if the rotor hub is decreased in thickness to realize a compact spindle motor, a contact area between the shaft and the rotor hub may be decreased, reducing coupling force between the shaft and the rotor hub. In this case, if an external impact occurs, the rotor hub and the shaft may be separated from each other.

### PRIOR ART DOCUMENTS

### Patent Documents

(Patent Document US Publication Application No. 2008-283120

### SUMMARY OF THE INVENTION

An aspect of the present invention provides a spindle motor capable of reducing an occurrence of a negative pressure therein.

Another aspect of the present invention provides a spindle motor in which a sealing part in which a gas-liquid surface is capable of being disposed is easily connected to a lower end of a bearing clearance to reduce an occurrence of a negative pressure.

Another aspect of the present invention provides a spindle motor capable of restraining damage due to an external impact.

According to an aspect of the present invention, there is provided a spindle motor including: a sleeve fixed to abase member; a shaft rotatably inserted into a shaft hole of the sleeve; and a rotor hub fixed to an upper end of the shaft, wherein a protrusion having a corresponding inclined surface that defines a bearing clearance together with an outer circumferential surface of the sleeve is disposed on an inner diameter part of the rotor hub.

The spindle motor may further include a thrust member fixed to an upper end of the sleeve.

A downwardly inclined surface disposed to face the corresponding inclined surface may be disposed on the sleeve.

The corresponding inclined surface and the downwardly inclined surface may be inclined at the same angle or different angles.

A circulation hole may be formed in the sleeve, the thrust member may be disposed in an installation groove of the sleeve to define a connection part connected to the circulation hole when the thrust member is disposed in the installation groove, and the connection part may connect a sealing part, in which a gas-liquid interface defined by the sleeve and the rotor hub is disposed, to the circulation hole.

An inner diameter part of the thrust member may have a thickness different from that of an outer diameter part of the thrust member.

The thrust member may have a trapezoidal cross-sectional shape.

An inclined surface may be disposed on the thrust member, and when the thrust member is disposed in the installation groove, a surface opposing the installation groove disposed to face the inclined surface may be spaced apart from the inclined surface by a predetermined distance to define the connection part.

An inclined surface may be disposed on the thrust member, a surface opposing the installation groove disposed to face the inclined surface may be inclined at an angle different from that of the inclined surface, and a clearance defined by the inclined surface and the opposite surface of the installation groove may be gradually widened outwardly in a radial direction to define the connection part.

An inclined surface may be disposed on the thrust member, a surface opposing the installation groove disposed to face the inclined surface may be bonded to the inclined surface, and a connection groove may be formed in at least one of the inclined surface and the opposite surface to define the connection part by the connection groove when the thrust member is disposed on the sleeve.

The connection groove may have a uniform width or is tapered toward an outer diameter part of the thrust member.

The thrust member may have at least an inner circumferential surface and bottom surface bonded to the sleeve.

Thrust dynamic pressure groove for generating thrust hydrodynamic pressure may be formed in a top surface of the thrust member.

The sleeve and the thrust member may be formed of different materials or coated with different materials.

The spindle motor may further include a cover member fixed to a bottom surface of the sleeve to prevent a lubricating fluid from leaking.

According to another aspect of the present invention, there is provided a spindle motor including: a sleeve fixed to a base member; a shaft rotatably inserted into a shaft hole of the sleeve; a rotor hub fixed to an upper end of the shaft; a thrust member fixed to an upper end of the sleeve; and a cover member fixed to a bottom surface of the sleeve to prevent a lubricating fluid from leaking, wherein a protrusion having a corresponding inclined surface that defines a bearing clearance together with an outer circumferential surface of the sleeve is disposed on an inner diameter part of the rotor hub, a downwardly inclined surface disposed to face the corresponding inclined surface is disposed on the sleeve, and the corresponding inclined surface and the downwardly inclined surface are inclined at the same angle or different angles.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is an enlarged view of portion A of FIG. 1;

FIG. 3 is a partially cutaway exploded perspective view of a sleeve and thrust member provided in the spindle motor according to an embodiment of the present invention;

FIG. 4 is a perspective view of the thrust member according to an embodiment of the present invention;

FIG. 5 is an enlarged view of portion B of FIG. 1;

FIG. 6 is a partially cutaway perspective view of a rotor hub according to an embodiment of the present invention;

FIG. 7 is an enlarged view of a portion of a spindle motor corresponding to portion A of FIG. 1 according to another embodiment of the present invention;

FIG. 8 is a perspective view of a sleeve and thrust member provided in the spindle motor according to another embodiment of the present invention;

FIG. 9 is a cross-sectional view taken along line X-X′ of FIG. 8;

FIG. 10 is a cross-sectional view taken along line Y-Y′ of FIG. 8; and

FIG. 11 is a perspective view of a thrust member provided in a spindle motor according to another embodiment of the present invention.

### DETAILED DESCRIPTION OF THE PREFERRED EMBODIMENT

Exemplary embodiments of the present invention will now be described below in detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the drawings, the thicknesses of layers and regions are exaggerated for clarity.

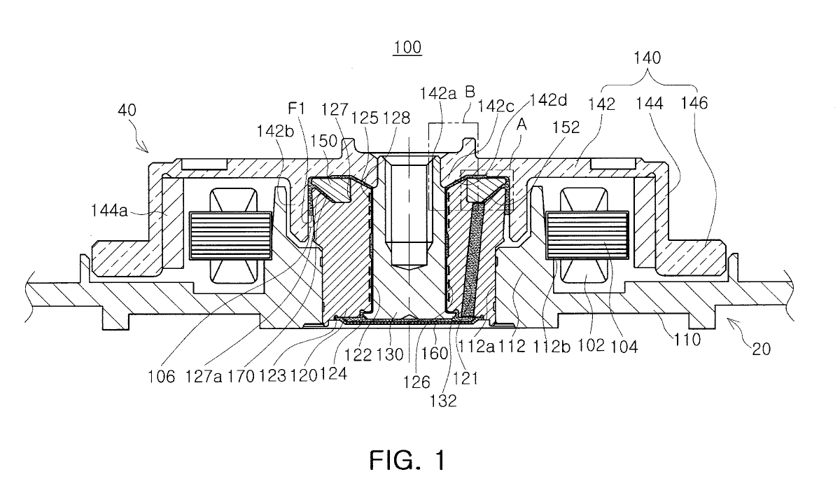

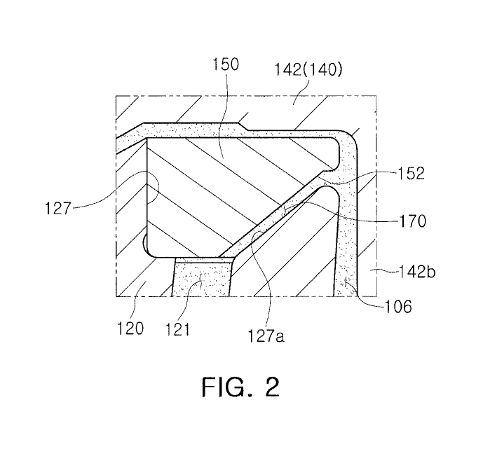

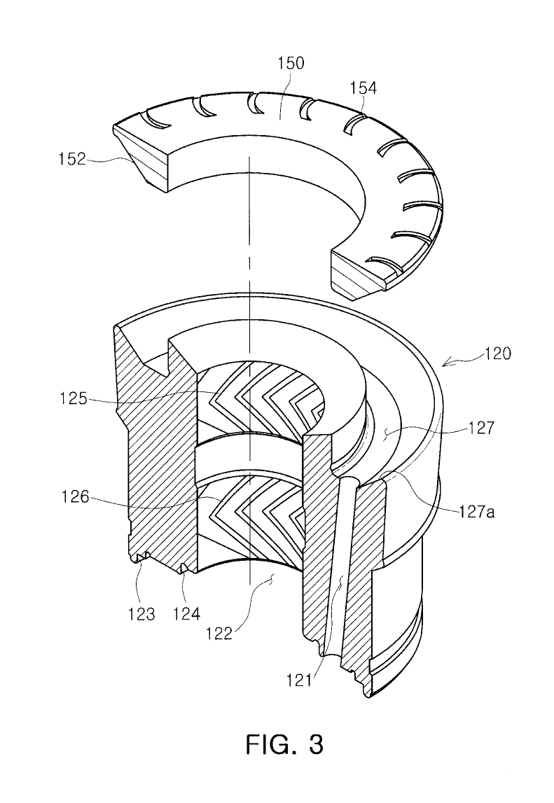

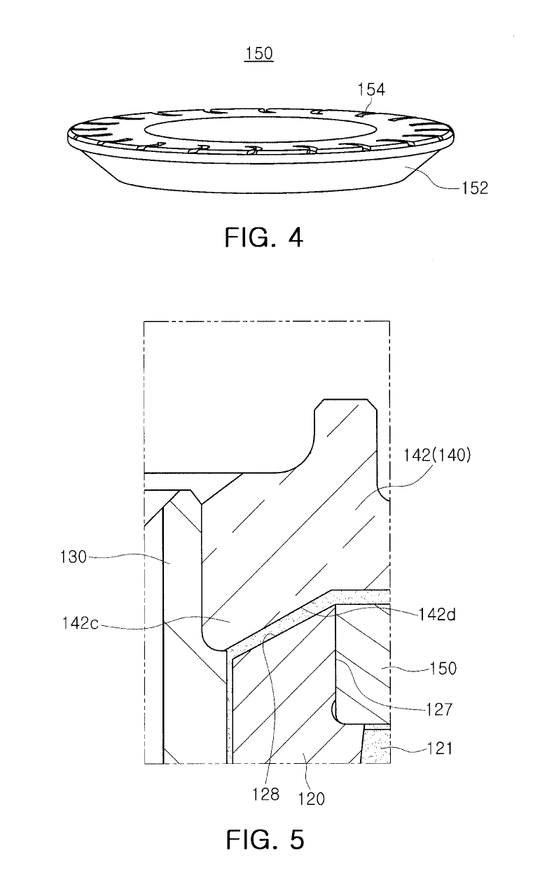

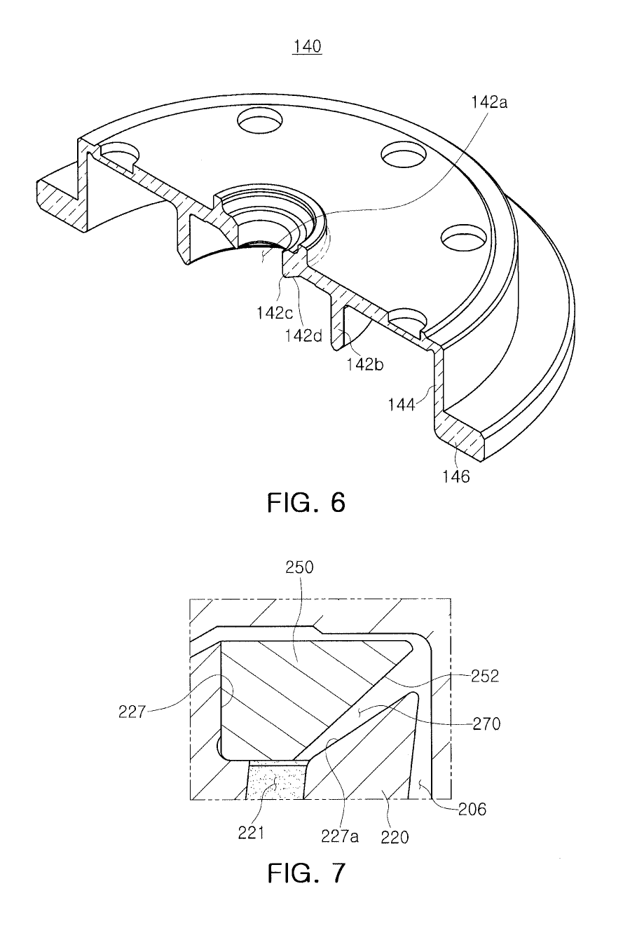

FIG. 1 is a schematic cross-sectional view of a spindle motor according to an embodiment of the present invention. FIG. 2 is an enlarged view of portion A of FIG. 1. FIG. 3 is a partially cutaway exploded perspective view of a sleeve and thrust member provided in the spindle motor according to an embodiment of the present invention. FIG. 4 is a perspective view of the thrust member according to an embodiment of the present invention. FIG. 5 is an enlarged view of portion B of FIG. 1. FIG. 6 is a partially cutaway perspective view of a rotor hub according to an embodiment of the present invention.

Referring to FIGS. 1 to 6, a spindle motor 100 according to an embodiment of the present invention may include, for example, a base member 110, a sleeve 120, a shaft 130, a rotor hub 140, a thrust member 150, and a cover member 160.

The spindle motor 100 may be a motor adopted for a recording disk driving device for driving a recording disk.

Here, terms with respect to directions will be defined. As shown in FIG. 1, an axial direction refers to a vertical direction, i.e., a direction upward from a lower portion of the shaft 130 or a direction downward from an upper portion of the shaft 130, and a radial direction refers to a horizontal direction, i.e., a direction toward the shaft 130 from an outer circumferential surface of the rotor hub 140 or a direction toward the outer circumferential surface of the rotor hub 140 from the shaft 130.

Also, a circumferential direction refers to a rotation direction along the outer circumferential surface of the rotor hub 140 or the shaft 130.

The base member 110 constitutes a stator 20 as a fixing member. Here, the stator 20 represents all fixing members except for rotation members. The stator 20 may include a base member 110, a sleeve 120, and the like.

Also, the base member 110 may include an installation wall part 112 into which the sleeve 120 is inserted. The installation wall part 112 protrudes upward in an axial direction. An installation hole 112a into which the sleeve 120 is inserted may be formed in the installation wall part 112.

Also, a support surface 112b for seating a stator core 104 on which a coil 102 is wound may be disposed on an outer circumferential surface of the installation wall part 112. That is, the stator core 104 may be fixedly installed on the outer circumferential surface of the installation wall part 112 by an adhesive in a state in which the stator core 104 is seated on the support surface 112b.

Alternatively, the stator coil 104 may be fitted into the outer circumferential surface of the installation wall part 112 without using an adhesive. That is, the installation method of the stator coil 104 is not limited to the method of using an adhesive.

Also, the base member 110 may be manufactured by using an aluminum (Al) material through die-casting. Alternatively, the base member 110 may be manufactured by using a steel plate through plastic working (e.g., press processing).

That is, the base member 110 may be manufactured by using various materials and methods, and is thus not limited to the base member 110 illustrated in the drawings.

The sleeve 120, together with the base member 110, may constitute the stator 20 as the fixing member. The sleeve 120 may be fixedly installed on the base member 110 and have a circulation hole 121 formed therein.

That is, the sleeve 120 may be inserted and fixed into the installation wall part 112. That is to say, a lower end of an outer circumferential surface of the sleeve 120 may be joined to an inner circumferential surface of the installation wall part 112 through at least one adhesive, welding, and press fitting.

Also, the circulation hole 121 may extend from a bottom surface of the sleeve 120 in an axial direction and be formed inclinedly. However, although the circulation hole extends in the axial direction and formed inclinedly in the current embodiment, the present invention is not limited thereto.

That is, the circulation hole 121 may extend in a radial direction parallel to a top surface of the base member 110. Also, the circulation hole 121 may be defined parallel to the shaft 130 in the axial direction. Also, the circulation hole 121 may include two holes, i.e., a hole extending in the axial direction and a hole extending in the radial direction.

A shaft hole 122 into which the shaft 130 is inserted may be formed in the sleeve 120. The shaft 130 may be inserted into the shaft hole 122 and rotatably supported by the sleeve 120.

Also, a mounting groove 123 on which the cover member 160 for preventing a lubricating fluid from leaking is disposed may be formed in a lower end of the sleeve 120. Also, when the cover member 160 is installed, a bearing clearance in which the lubricating fluid is filled may be defined by a top surface of the cover member 160 and a bottom surface of the sleeve 120.

The bearing clearance will now be described.

The bearing clearance represents a clearance in which the lubricating fluid is filled. That is, a clearance defined by an inner circumferential surface of the sleeve 120 and an outer circumferential surface of the shaft 130, a clearance defined by the sleeve 120 and the rotor hub 140, a clearance defined by the cover member 160 and the sleeve 120, and a clearance defined by the cover member 160 and the shaft 130 may be defined as the bearing clearance.

Also, the spindle motor 100 according to the current embodiment adopts a structure in which the lubricating fluid is filled into the whole bearing clearance. Thus, this structure may be called a full-fill structure.

A stepped groove 124 may be formed in the lower end of the sleeve 120. The stepped groove 124 will be described in detail later.

Also, upper and lower radial dynamic pressure grooves 125 and 126 for generating a hydrodynamic pressure when the shaft 130 rotates may be formed in an inner circumferential surface of the sleeve 120. Also, the upper and lower radial dynamic pressure grooves 125 and 126 may be spaced apart from each other by a predetermined distance. Respective upper and lower radial dynamic pressure grooves 125 and 126 may have a herringbone or spiral pattern.

However, the present invention is not limited to the upper and lower radial dynamic pressure grooves 125 and 126 formed in the inner circumferential surface of the sleeve 120. For example, the upper and lower radial dynamic pressure grooves 125 and 126 may be formed in an outer circumferential surface of the shaft 130.

Also, an installation groove 127 in which the thrust member 150 is disposed may be formed in an upper end of the sleeve 120. The installation groove 127 may have a shape corresponding to that of the thrust member 150. Also, one side of the circulation hole 121 may be opened through a bottom surface of the installation groove 127.

Detailed descriptions with respect to the installation groove 127 will be described in more detail when the thrust member 150 is described.

Also, a downwardly inclined surface 128, inclined downwardly toward the shaft hole 122 may be disposed on the top surface of the sleeve 120. The downwardly inclined surface 128 is disposed inside the installation groove 127 in the radial direction so that the rotor hub 140 has a relatively thick inner diameter part.

The shaft 130 constitutes a rotor 40 as a rotation member. Here, the rotor 40 represents a rotation member rotatably supported by the stator 20.

The shaft 130 may be rotatably supported by the sleeve 120. Also, a stopper 132 inserted into the stepped groove 124 may be disposed on a lower end of the shaft 130.

The stopper 132 may extend outwardly from the lower end of the shaft 130 in the radial direction. Also, the stopper 132 may prevent the shaft 130 from being moved toward an upper side of the sleeve 120 and the shaft 130 from being simultaneously excessively lifted.

That is, the stopper 132 may prevent the shaft 130 from being moved toward the upper side of the sleeve 120 and separated from the sleeve 120 due to an external impact. When the shaft 130 rotates, the shaft 130 is lifted by a predetermined height. Here, the stopper 132 may prevent the shaft 130 from being excessively lifted.

Also, the rotor hub 140 may be coupled to an upper end of the shaft 130. For this, when the shaft 130 is disposed on the sleeve 120, the upper end of the shaft 130 may protrude upward from the sleeve 120.

The rotor hub 140, together with the shaft 130, may constitute the rotor 40 as a rotation member. The rotor hub 140 is fixedly disposed on the upper end of the shaft 130 and linked with the shaft 130 to rotate.

The rotor hub 140 may include a rotor hub body 142 having a mounting hole 142a into which the upper end of the shaft 130 is inserted, a magnet mount part 144 extending from an edge of the rotor hub body 142 in the axial direction, and a disk seat part 146 extending outwardly from an end of the magnet mount part 144 in the radial direction.

Also, a driving magnet 144a is disposed on an inner surface of the magnet mount part 144. The driving magnet 144a is disposed to face a front end of the stator core 104 around which the coil 102 is wound.

The driving magnet 144a may have a circular ring shape. The driving magnet 144a may be a permanent magnet in which an N pole and an S pole are alternately magnetized along a circumference direction to generate a magnetic force having predetermined intensity.

Here, rotation of the rotor hub 140 will be described in brief. A power is supplied to the coil 102 wound around the stator core 104 to generate a driving force for rotating the rotor hub 140 through an electromagnetic interaction between the driving magnet 144a and the stator coil 104 around which the coil 102 is wound.

Thus, the rotor hub 140 rotates. Also, the shaft 130 on which the rotor hub 140 is fixedly disposed may be linked with the rotor hub 140 to rotate by the rotation of the rotor hub 140.

An extension wall part 142b extending downward in the axial direction may be disposed on the rotor hub body 142 so that the extension wall part 142b together with the outer circumferential surface of the sleeve 120 defines an interface F1 between the lubricating fluid and air, i.e., a gas-liquid interface F1.

An inner surface of the extension wall part 142b may be disposed to face the outer circumferential surface of the sleeve 120. At least one of the outer circumferential surface of the sleeve 120 and the inner surface of the extension wall part 142b may be inclined to define the gas-liquid interface F1.

That is, at least one of the outer circumferential surface of the sleeve 120 and the inner surface of the extension wall part 142b may be inclined to define the gas-liquid interface F1 through a capillary phenomenon.

Also, all of the outer circumferential surface of the sleeve 120 and the inner surface of the extension wall part 142b may be inclined. In this case, the outer circumferential surface of the sleeve 120 and the inner surface of the extension wall part 142b may have inclined angles different from each other.

A space defined by the inner surface of the extension wall part 142b and the outer circumferential surface of the sleeve 120 may be called a sealing part 106. The gas-liquid interface F1 may be disposed on the sealing part 106.

Also, a protrusion 142c inclinedly protruding to correspond to the downwardly inclined surface 128 of the sleeve 120 may be disposed on the inner diameter part of the rotor hub body 142.

The protrusion 142c may increase an area of the inner circumferential surface of the rotor hub body 142. Thus, a contact area between the rotor hub 140 and the shaft 130 may increase.

As a result, as the contact area between the rotor hub 140 and the shaft 130 increases, a coupling force between the rotor hub 140 and the shaft 130 may increase.

In detail, the rotor hub 140 and the shaft 130 are coupled to each other by an adhesive and/or press-fitted with respect to each other. In this case, the rotor hub 130 and the shaft 130 should be coupled to each other by a predetermined coupling force so that the rotor hub 130 and the shaft 130 are not separated from each other even though an external impact is applied to the rotor hub 140 and the shaft 130.

That is, the inner circumferential surface of the rotor hub body 142 having the mounting hole 142a should have an axial direction length sufficient to generate a coupling force greater than a predetermined force by contacting the shaft 130.

For this, the protrusion 142c is disposed on the rotor hub body 142. Thus, a contact area between the shaft 130 and the rotor hub body 142 may increase by the protrusion 142c. As a result, the coupling force between the shaft 130 and the rotor hub 140 may further increase.

In addition, the protrusion 142c may have a corresponding inclined surface 142d to correspond to the downwardly inclined surface 128 of the sleeve 120.

Thus, when an external impact is applied, damage to the rotor hub body 142 at the inner diameter part of the rotor hub body 142 may be further restrained.

That is, if a bottom surface of the protrusion 142c is not inclined (e.g., the protrusion 142 has a square cross-sectional), when an external impact is applied, an edge side of the protrusion 142c may be easily damaged. In this case, separated foreign matters due to the damage may be introduced through the bearing clearance to deteriorate rotational characteristics of the shaft 130.

However, as described above, since the corresponding inclined surface 142d of the protrusion 142c and the downwardly inclined surface 128 of the sleeve 120 disposed to face the corresponding inclined surface 142d are inclined, the damage due to the external impact may be reduced. Furthermore, the deterioration of the rotational characteristics of the shaft 130 may be prevented.

Also, if the bottom surface of the protrusion 142c is not inclined (e.g., the protrusion 142 has a square shape in cross-section), since a bearing clearance defined by the protrusion 142c and the sleeve 120 is bent at about 90 degrees, the lubricating fluid may be interrupted in flow and changed in pressure. As a result, bubbles may occur in the lubricating fluid.

However, as described above, since the corresponding inclined surface 142d of the protrusion 142c and the downwardly inclined surface 128 of the sleeve 120 are inclined, the lubricating fluid may more easily flow. Furthermore, the pressure change may be reduced.

In addition, when an external impact is applied, external force may be distributed as horizontal force and vertical force by the inclined protrusion 142c. Thus, damage to the rotor hub 140 due to an external impact may be further reduced.

As described above, even though the rotor hub body 142 is reduced in thickness to realize a compact spindle motor, the reduction of the contact area between the shaft 130 and the inner diameter part of the rotor hub body 142 may be restrained to prevent the coupling force between the shaft 130 and the rotor hub 140 from being reduced. Thus, the separation of the shaft 130 from the rotor hub 140 due to the external impact may be prevented.

In addition, the corresponding inclined surface 142d of the protrusion 142c may be inclined to reduce damage to the rotor hub body 142. Thus, the lubricating fluid may more easily flow to reduce the pressure change thereof.

Although the corresponding inclined surface 142d of the protrusion 142c and the downwardly inclined surface 128 of the sleeve 120 are inclined at the same angle so that the corresponding inclined surface 142d and the downwardly inclined surface 128 are disposed parallel to each other in the current embodiment, the present invention is not limited thereto.

That is, the corresponding inclined surface 142d and the downwardly inclined surface 128 may be inclined at different angles.

The thrust member 150 together with the base member 110 and the sleeve 120 may constitute the stator 20 as a fixing member. Also, the thrust member 150 is disposed in the installation groove 127 of the sleeve 120. When the thrust member 150 is disposed in the installation groove 127, the thrust member 150 may define a connection part 170 connected to the circulation hole 121.

The connection part 170 is defined by the sleeve 120 and the rotor hub 140 to connect the sealing part 106 disposed on the gas-liquid interface F1 to the circulation hole 121. Detailed descriptions with respect to the connection part 170 will be described later.

The thrust member 150 may have an inner diameter part thickness (i.e., a length of an inner diameter part in the axial direction) and an outer diameter part thickness (i.e., a length of an outer diameter part in the axial direction) which are different from each other.

For example, the thrust member 150 may have an approximately trapezoidal cross-sectional shape. In detail, a length of an upper end of the thrust member 150 in the radial direction may be longer than that of a lower end of the thrust member 150 in the radial direction. The thrust member 150 may have a uniform inner diameter.

Also, an inner circumferential surface of the thrust member 150 may contact an inner wall surface of the installation groove 127. A bottom surface of the thrust member 150 may contact the bottom surface of the installation groove 127. An inclined surface 152 extending from the bottom surface of the thrust member 150 may be disposed on the thrust member 150.

As described above, since the thrust member 150 has the approximately trapezoidal cross-sectional shape, when an external impact is applied, damage of the thrust member 150 may be reduced.

In the case in which the thrust member 150 is disposed in the installation groove 127, an opposite surface 127a of the installation groove 127 disposed to face the inclined surface 152 may be spaced apart from the inclined surface by a predetermined distance 152 to define the connection part 170.

Also, in the case in which the thrust member 150 is disposed on the sleeve 120, the thrust member 150 and the sleeve 120 define the connection part 170 to connect the circulation hole 121 to the sealing part 106.

Thus, an occurrence of a negative pressure may be reduced by disposing the thrust member 150 on the sleeve 120, because the bearing clearance defined by the sleeve 120 and the cover member 160 communicates with the sealing part 106.

That is, since the bearing clearance defined by the sleeve 120 and the cover member 160 and the sealing part 106 communicate with each other through the circulation hole 121 and the connection part 170, the occurrence of the negative pressure in the bearing clearance defined by the sleeve 120 and the cover member 160 may be reduced.

Furthermore, the bubbles generated in the bearing clearance may be more smoothly discharged to the outside of the bearing clearance.

Also, the configuration for the reduction of the occurrence of the negative pressure may be easily formed when compared to a case in which only the circulation hole is defined so that the bearing clearance defined by the sleeve 120 and the cover member 160 communicates with the sealing part 106. That is, manufacturing defects of the sleeve 120 occurring when the circulation hole is defined so that the bearing clearance defined by the sleeve 120 and the cover member 160 communicates with the sealing part 106 may be reduced.

The thrust member 150 may be bonded to the installation groove 127 of the sleeve 120 by an adhesive. Also, a groove in which the adhesive is filled may be formed in an edge at which the inner wall surface of the installation groove 127 meets the bottom surface to increase coupling force between the thrust member 150 and the sleeve 120.

Also, the thrust member 150 may be formed of a material different from that of the sleeve 120. That is, the thrust member 150 may be formed of a material having superior wear resistance.

However, the present invention is not limited to the material of the thrust member. For example, the thrust member 150 may be formed of the same material as the sleeve 120. In this case, the thrust member 150 and the sleeve 120 may have outer surfaces coated with different materials, respectively. That is, the outer surface of the thrust member 150 may be coated with a material for improving wear resistance.

A thrust dynamic pressure groove 154 may be formed in a top surface of the thrust member 150. However, the present invention is not limited to the thrust dynamic pressure groove 154 formed in the top surface of the thrust member 150. For example, the thrust dynamic pressure groove 154 may be formed in the rotor hub 140.

The cover member 160 together with the base member 110, the sleeve 120, and the thrust member 150 may constitute the stator 20 as a fixing member. The cover member 160 may be fixedly disposed on the bottom surface of the sleeve 120 to prevent the lubricating fluid from leaking.

That is, the cover member 160 may be bonded to the mounting groove 123 of the sleeve 120 through at least one of adhesion and welding.

As described above, since the thrust member 150 has the approximately trapezoidal cross-sectional shape, when an external impact is applied, the damage of the thrust member 150 may be reduced.

Also, since the thrust member 150 is disposed on the sleeve 120 so that the circulation hole 121 of the sleeve 120 communicates with the sealing part 106, the occurrence of the negative pressure in the bearing clearance defined by the sleeve 120 and the cover member 160 may be reduced.

Furthermore, the bubbles generated in the bearing clearance may be more smoothly discharged to the outside of the bearing clearance.

Also, the configuration for the reduction of the occurrence of negative pressure may be easily formed when compared to a case in which only the circulation hole is formed so that the bearing clearance formed by the sleeve 120 and the cover member 160 communicates with the sealing part 106.

That is, manufacturing defects of the sleeve 120 occurring when the circulation hole is formed so that the bearing clearance formed by the sleeve 120 and the cover member 160 communicates with the sealing part 106 may be reduced.

In addition, since a portion disposed to face the rotor hub 140 of the thrust member 150 is formed of a material having high wear resistance, or the thrust member 150 having the outer surface coated with a material having high wear resistance is disposed, an occurrence of the foreign objects due to wear may be reduced.

Also, the reduction of the hydrodynamic pressure which occurs from the thrust dynamic pressure groove 154 by the wear may be restrained by the thrust member 150, formed of the material having the high wear resistance or has the outer surface coated with the material having the high wear resistance.

Also, the contact area between the shaft 130 and the rotor hub body 142 may increase through the protrusion 142c disposed on the rotor hub body 142. Thus, the coupling force between the shaft 130 and the rotor hub 140 may further increase.

In addition, since the protrusion 142 has the corresponding inclined surface 142d, when the external impact is applied, the damage of the rotor hub body 142 at the inner diameter part of the rotor hub body 142 may be more restricted.

Also, the occurrence of foreign objects due to the damage of the protrusion 142c when the external impact is applied may be reduced by the corresponding inclined surface 142d.

Also, when compared to a case in which the bottom surface of the protrusion 142c is not inclined (e.g., the protrusion 142 has a square cross-sectional shape), the lubricating fluid may more easily flow by the corresponding inclined surface 142d to reduce the pressure change and restrain the occurrence of bubbles.

Hereinafter, a spindle motor according to another embodiment of the present invention will be described with reference to the accompanying drawings. However, the same constitutions as those of the above-described spindle motor according to an embodiment of the present invention will be omitted in drawings and detailed description.

FIG. 7 is an enlarged view of a portion of a spindle motor corresponding to portion A of FIG. 1 according to another embodiment of the present invention.

Referring to FIG. 7, a thrust member 250 may have an approximately trapezoidal cross-sectional shape.

Also, an inner circumferential surface of the thrust member 250 may contact an inner wall surface of an installation groove 227. A bottom surface of the thrust member 250 may contact a bottom surface of the installation groove 227. Also, an inclined surface 252 extending from the bottom surface of the thrust member 250 may be disposed on the thrust member 250.

In a case in which the thrust member 250 is disposed in the installation groove 227, an opposite surface 227a of the installation groove 227 disposed to face the inclined surface 252 may be spaced apart from the inclined surface by a predetermined distance 252 to define a connection part 270.

Also, in the case where the thrust member 250 is disposed on a sleeve 220, the thrust member 250 and the sleeve 220 define the connection part 270 to connect a circulation hole 221 to a sealing part 206.

Also, the inclined surface 252 and the opposite surface 227a of the installation groove 227 disposed to face the inclined surface 252 may be inclined at different angles.

Also, a clearance defined by the inclined surface 252 and the opposite surface 227a of the installation groove 227 may be gradually widened outwardly in a radial direction to define the connection part 270.

That is, the clearance may be tapered from one end of the connection part 270 connected to the circulation hole 221 toward the other end of the connection part 270 connected to the sealing part 206.

Thus, an occurrence of bubbles in the connection part 270 may be reduced.

Hereinafter, a spindle motor according to another embodiment of the present invention will be described with reference to the accompanying drawings. However, the same constitutions as those of the above-described spindle motor according to an embodiment of the present invention will be omitted in the drawings and the detailed description.

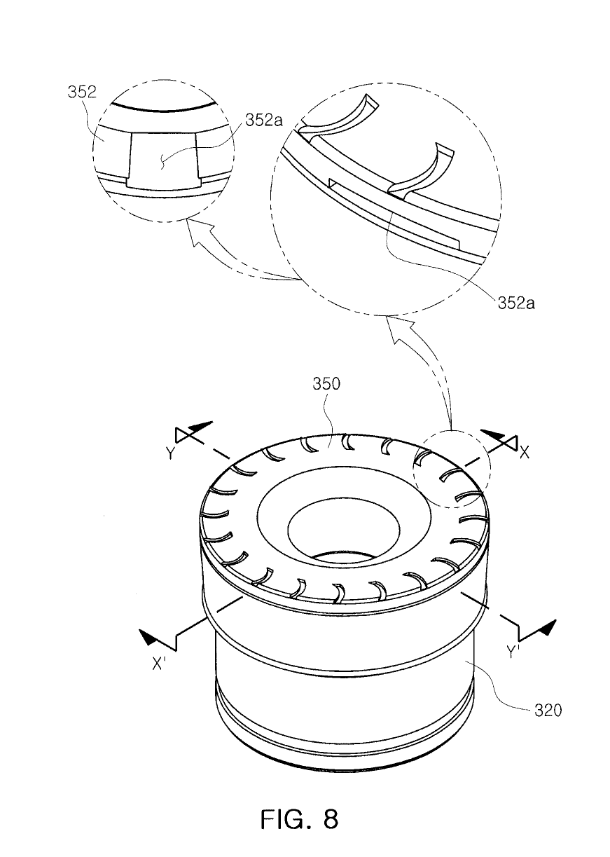

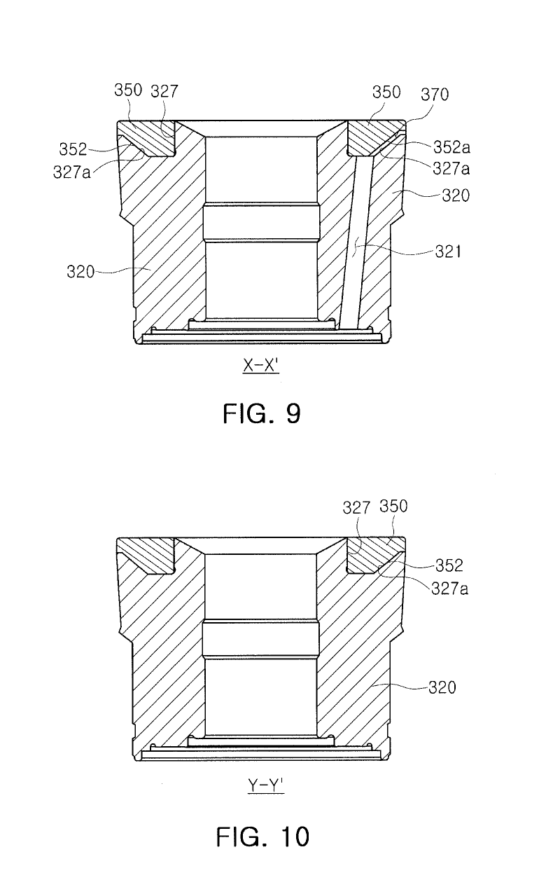

FIG. 8 is a perspective view of a sleeve and thrust member provided in the spindle motor according to another embodiment of the present invention. FIG. 9 is a cross-sectional view taken along line X-X′ of FIG. 8. FIG. 10 is a cross-sectional view taken along line Y-Y′ of FIG. 8.

Referring to FIGS. 8 to 10, an inclined surface 352 may be disposed on a thrust member 350. Also, in a case where the thrust member 350 is disposed on a sleeve 320, the inclined surface 352 of the thrust member 350 may be bonded to an opposite surface 327a of an insulation groove 327.

A connection groove 352a may be formed in the inclined surface 352. Also, in a case in which the thrust member 350 is disposed on a sleeve 320, a connection part 370 may be defined by the connection groove 352a.

As described above, since the inclined surface 352 is bonded to the opposite surface 327a of the installation groove 327, coupling strength between the sleeve 320 and the thrust member 350 may increase.

The connection groove 352a may have a uniform width.

However, although the connection groove 352a is formed in the inclined surface 352 in the current embodiment, the present invention is not limited thereto. For example, the connection groove 352a may be formed in the opposite surface 327a of the installation groove 327 disposed to face the inclined surface 352.

Hereinafter, a spindle motor according to further another embodiment of the present invention will be described with reference to the accompanying drawings. However, the same constitutions as those of the above-described spindle motor according to an embodiment of the present invention will be omitted in drawings and detailed description.

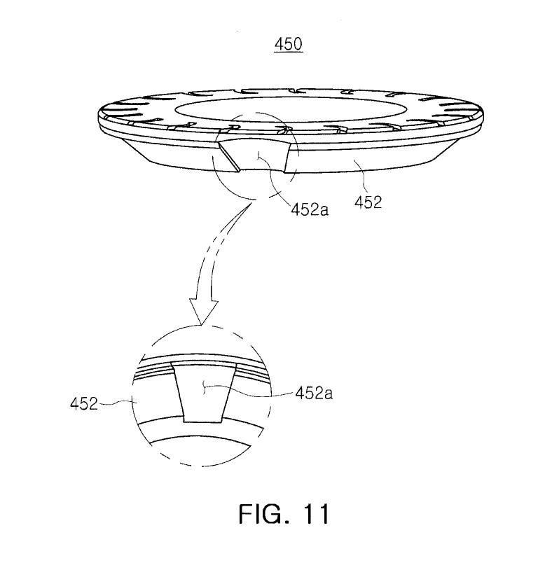

FIG. 11 is a perspective view of a thrust member provided in a spindle motor according to another embodiment of the present invention.

Referring to FIG. 11, an inclined surface 452 may be disposed on a thrust member 450. A connection groove 452a may be formed in the inclined surface 452. In a case in which the thrust member 450 is disposed on a sleeve (see reference numeral 320 of FIG. 10), a connection part (see reference numeral 370 of FIG. 10) may be defined by the connection groove 452a.

The connection groove 452a may be tapered. That is, the connection groove 452a may have a width gradually increasing toward the outside of a radial direction. Thus, an occurrence of bubbles may be restrained.

Since the thrust member has the approximately trapezoidal cross-sectional shape, when an external impact is applied, damage to the thrust member may be reduced.

Also, since the thrust member is disposed on the sleeve so that the circulation hole of the sleeve communicates with the sealing part, the occurrence of negative pressure in the bearing clearance formed by the sleeve and the cover member may be reduced.

Furthermore, bubbles generated in the bearing clearance may be more smoothly discharged to the outside of the bearing clearance.

Also, the configuration for the reduction of the occurrence of the negative pressure may be easily formed when compared to the case in which only the circulation hole is defined so that the bearing clearance defined by the sleeve and the cover member communicates with the sealing part.

That is, the occurrence of the manufacturing defects of the sleeve occurring when the circulation hole is defined so that the bearing clearance defined by the sleeve and the cover member communicates with the sealing part may be reduced.

In addition, since the portion disposed to face the rotor hub of the thrust member is formed of the material having high wear resistance, or the thrust member having an outer surface coated with the material having high wear resistance is disposed, the occurrence of the foreign matters due to the wear may be reduced.

Also, the reduction of the hydrodynamic pressure which occurs from the thrust dynamic pressure groove by the wear may be restrained by the thrust member, formed of the material having the high wear resistance or has the outer surface coated with the material having the high wear resistance.

Also, the contact area between the shaft and the rotor hub body may increase through the protrusion disposed on the rotor hub body. Thus, the coupling force between the shaft and the rotor hub may further increase.

In addition, since the protrusion has the corresponding inclined surface, when an external impact is applied, damage to the rotor hub body on the inner diameter side of the rotor hub body may be further restrained.

Also, the occurrence of the foreign objects due to damage to the protrusion when an external impact is applied may be reduced by the corresponding inclined surface.

Also, when compared to the case in which the bottom surface of the protrusion is not inclined (e.g., the protrusion has the square shape in cross-section), the lubricating fluid may more easily flow by the corresponding inclined surface to reduce the pressure change and restrain the occurrence of the bubbles.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve fixed to a base member;
a shaft rotatably inserted into a shaft hole of the sleeve; and
a rotor hub fixed to an upper end of the shaft,
wherein a protrusion having a corresponding inclined surface that defines a bearing clearance together with an outer circumferential surface of the sleeve is disposed on an inner diameter part of the rotor hub.

2. The spindle motor of claim 1, further comprising a thrust member fixed to an upper end of the sleeve.

3. The spindle motor of claim 1, wherein a downwardly inclined surface disposed to face the corresponding inclined surface is disposed on the sleeve.

4. The spindle motor of claim 3, wherein the corresponding inclined surface and the downwardly inclined surface are inclined at the same angle or different angles.

5. The spindle motor of claim 2, wherein a circulation hole is formed in the sleeve,
the thrust member is disposed in an installation groove of the sleeve to define a connection part connected to the circulation hole when the thrust member is disposed in the installation groove, and
the connection part connects a sealing part in which a gas-liquid interface defined by the sleeve and the rotor hub is disposed in the circulation hole.

6. The spindle motor of claim 3, wherein an inner diameter part of the thrust member has a thickness different from that of an outer diameter part of the thrust member.

7. The spindle motor of claim 6, wherein the thrust member has a trapezoidal cross-sectional shape.

8. The spindle motor of claim 7, wherein an inclined surface is disposed on the thrust member, and
when the thrust member is disposed in the installation groove, a surface opposing the installation groove disposed to face the inclined surface is spaced apart from the inclined surface by a predetermined distance to define the connection part.

9. The spindle motor of claim 7, wherein an inclined surface is disposed on the thrust member,
a surface opposing the installation groove disposed to face the inclined surface is inclined at an angle different from that of the inclined surface, and
a clearance defined by the inclined surface and the opposite surface of the installation groove is gradually widened outwardly in a radial direction to define the connection part.

10. The spindle motor of claim 7, wherein an inclined surface is disposed on the thrust member,
a surface opposing the installation groove disposed to face the inclined surface is bonded to the inclined surface, and
a connection groove is formed in at least one of the inclined surface and the opposite surface to define the connection part by the connection groove when the thrust member is disposed on the sleeve.

11. The spindle motor of claim 10, wherein the connection groove has a uniform width or is tapered toward an outer diameter part of the thrust member.

12. The spindle motor of claim 7, wherein the thrust member has at least an inner circumferential surface and bottom surface bonded to the sleeve.

13. The spindle motor of claim 2, wherein thrust dynamic pressure groove for generating a thrust hydrodynamic pressure is formed in a top surface of the thrust member.

14. The spindle motor of claim 2, wherein the sleeve and the thrust member are formed of different materials or coated with different materials.

15. The spindle motor of claim 1, further comprising a cover member fixed to a bottom surface of the sleeve to prevent a lubricating fluid from leaking.

16. A spindle motor comprising:
a sleeve fixed to a base member;
a shaft rotatably inserted into a shaft hole of the sleeve;
a rotor hub fixed to an upper end of the shaft;
a thrust member fixed to an upper end of the sleeve; and
a cover member fixed to a bottom surface of the sleeve to prevent a lubricating fluid from leaking,
wherein a protrusion having a corresponding inclined surface that defines a bearing clearance together with an outer circumferential surface of the sleeve is disposed on an inner diameter part of the rotor hub,
a downwardly inclined surface disposed to face the corresponding inclined surface is disposed on the sleeve, and
the corresponding inclined surface and the downwardly inclined surface are inclined at the same angle or different angles.
